(19) United States
(12) Patent Application Publication
(10) Pub. No.: US 2009/0106389 A1
(43) Pub. Date: Apr. 23, 2009

(54) Sharing Multimedia

(76) Inventors: Vesa-Matti Hakkarainen, Tampere (FI); Arto Leppisaari, Kangasala (FI)

Correspondence Address: Hollingsworth & Funk, LLC, 8009 34th Avenue South, Suite 125, Minneapolis, MN, 54425, US

(21) Appl. No.: 12/224,348

(22) PCT Filed: Feb. 22, 2007
(86) PCT No.: PCT/FI2007/050095

§ 371 Date: Aug. 25, 2008

(30) Foreign Application Priority Data
Feb. 27, 2006 (FI) 20065137

(51) Int. Cl. G06F 15/16

(52) U.S. Cl. 709/217; 709/231

(57) ABSTRACT

In order to enable contents to be shared between participants in group communication when the contents are located in a by a communication server (501), a solution in which a user terminal sets us a transport mechanism between the media server and the communication server for delivering the contents from media server to the communication server so that the contents are not passing through the user terminal (507), and controls delivery of the contents (508), is provided.

### FIELD OF THE INVENTION

The present invention relates to sharing a media stream, such as a multimedia stream, in a communications system.

### BACKGROUND ART

One special feature offered in mobile communication systems is group communication. The term “group”, as used herein, refers to any logical group of two or more users intended to participate in the same group communication. One example of group communication is a group call, which is a call in which all participants may take turns to speak and to listen to each other.

Conventionally, group communication has been available only in trunked mobile communication systems, such as Professional Mobile Radio or Private Mobile Radio (PMR) systems, such as TETRA (Terrestrial Trunked Radio), which are special radio systems primarily intended for professional and governmental users. Thanks to the evolvement of communication technology, particularly IP-based communication technology, and end user terminals, a group communication service is now available also in public mobile communication systems. An example of such a service is Push-to-talk over Cellular (PoC), which allows user voice communications to be shared with a single recipient (1-to-1) or between groups of recipients as in a group chat session (1-to-many) over mobile networks. The PoC service is implemented so that a PoC server, or a server system, receives voice from one participant in the conversation and sends it to other participants of the session.

While the communication technology has evolved, also user requirements have evolved, one of the requirements for the group service being that sharing contents in a media server should be possible without a user first loading the contents to his/her user terminal. A problem with the above described arrangement is that, for the time being, no mechanism exist with which a PoC server would be able to share contents in another server to group members.

### SUMMARY

An object of the present invention is thus to provide a solution as to how to implement sharing of multimedia contents from a media server to participants. The objects of the invention are achieved by a method, a system, a user terminal, a communication server, and a computer program product which are characterized by what is stated in the independent claims. Preferred embodiments of the invention are disclosed in the dependent claims.

The invention is based on realizing the problem and solving it by a user terminal setting up a transport mechanism for a media stream between a communication server providing sharing of information to user terminals and a media server containing the information to be shared, and controlling the media stream between the servers by the user terminal.

The present invention provides an easy-to-implement solution for sharing a media stream originating from a media server. An advantage is that the media server needs not to know that the stream goes to a group server and the group server and other participants receiving the stream need not to know that the stream originates from the media server.

### BRIEF DESCRIPTION OF THE DRAWINGS

In the following the invention will be described in greater detail by means of preferred embodiments and with reference to the attached drawings, in which

FIG. 1 illustrates an example of a general architecture of a communication system providing a group communication service;

FIG. 2 is a signaling diagram illustrating signaling according to an embodiment;

FIGS. 3 and 4 illustrate media stream offers according to an embodiment;

FIG. 5 is a flow chart illustrating functionality of a user terminal according to an embodiment; and

FIG. 6 is a flow chart illustrating functionality of a communication server according to an embodiment.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

The present invention is applicable to any user terminal, server and/or to any communication system or any combination of different communication systems that support group communication and provide(s) sharing of contents between group members. No limitations exist to the contents type, nor to the group type. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to an embodiment of the invention. Therefore, all words and expressions should be interpreted broadly and they are intended to illustrate, not to restrict, the invention.

The term group communication covers here all communication involving a usage of an entity, such as a server, that maintains information on participants of the communication. Such group communication may include data calls, audio calls, video calls, multimedia calls, messaging, electronic mail, etc. Examples of service applications providing such group communication include PoC, conferencing and different chatting applications. Contents to be shared may be any kind of data which may be shared in real-time or near real-time, such as text, voice, video, multimedia, application specific data, etc., and which may include both live data feeds and stored data or data clips.

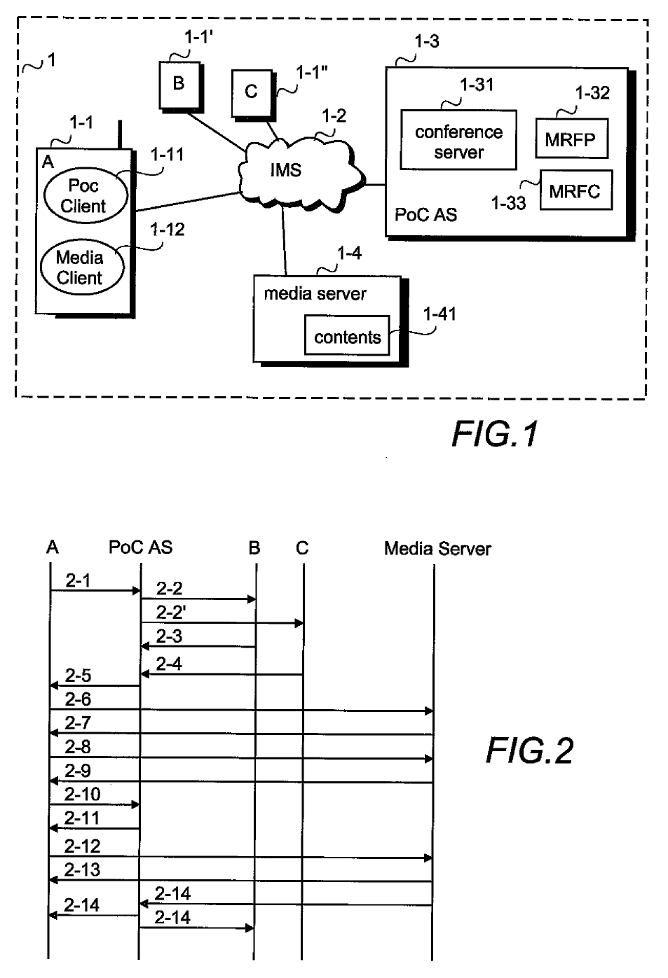

In the following, embodiments will be described using, as an example of a system architecture whereto the embodiments may be applied, an architecture based on SIP (Session Initiation Protocol) providing a tool to build a multimedia architecture and PoC providing group communication without restricting the embodiments to such an architecture, however. SIP is an Internet Engineering Task Force (IETF) defined application-layer control (signaling) protocol for creating, modifying, and terminating sessions with one or more participants. SIP is not vertically integrated into a communication system but a tool to build multimedia architecture. More detailed information on SIP, such as IETF specifications and Internet Drafts, can be found at http://www.ieff.org. PoC specification is an industry specification which is developed currently by a PoC working group under the OMA (Open Mobile Alliance). PoC can be provided as a packet-based user-level or application-level service so that the underlying communications system only provides the basic connections (i.e. IP connections) between PoC communications applications in user terminals and a PoC service provided by a communication server system, or a communication server illustrated by PoC AS in FIG. 1. PoC specification and more detailed information on PoC can be found via the Internet pages at www.openmobilealliance.org.

A general architecture of a communication system providing a group communication service utilizing SIP and PoC is illustrated in FIG. 1. FIG. 1 is a simplified system architecture only showing some elements and functional entities, all being logical units whose implementation may differ from what is shown. A communication system 1 illustrated in FIG. 1 comprises user terminals A 1-1, B 1-1′ and C 1-1″, an IMS network 1-2, PoC AS 1-3, and a media server 1-4. It is apparent to a person skilled in the art that the systems also comprise other functions and structures. It should be appreciated that the type of the underlying network layer (i.e. “the communications system”), the functions, structures, elements and the protocols used in or for group communication or for negotiating a media stream or for transmitting the media stream, and the type of the group communication are irrelevant to the actual invention. Furthermore, they are considered well known to a person skilled in the art since they are publicly available in different specifications, such as the 3GPP specifications, the OMA specifications and the IETF specifications. Therefore, they need not to be discussed in more detail here. An aspect of the invention primarily relates to sharing contents located in a media server between participants in a group communication through a communication server, i.e. PoC AS.

The user terminal A 1-1 illustrates a generic functional block diagram for a device according to an exemplary embodiment. The device also includes means and functionalities which are not shown in FIG. 1 and which are apparent to one skilled in the art, such as user interface(s), operating functionalities, microprocessor(s) for executing applications and programs, receiver(s) (receiving unit(s)) for receiving different inputs, information and messages, transmitter(s) (sending unit(s)) for sending different outputs, information and messages, etc. The device can be a wireless device, such as mobile user equipment, or it can be a device connected by a fixed connection, such as a dispatcher station. Herein the term user terminal is used for referring to any device or user equipment allowing the user to access network services.

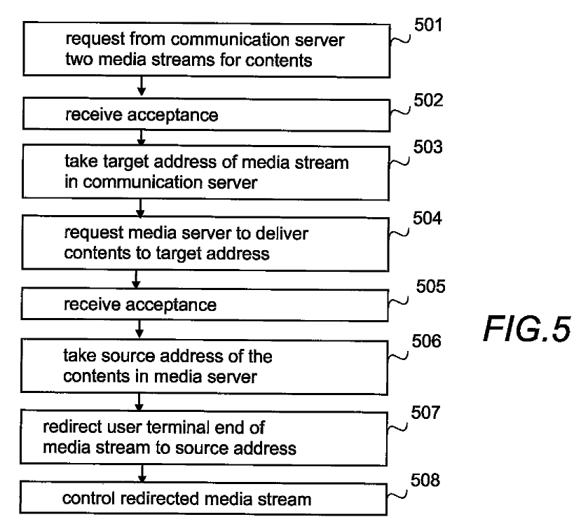

The user terminal A 1-1 comprises a PoC client 1-11 allowing, among other things, PoC session initiations and offering of media streams to share contents with other session participants, and a media client 1-12 for set-ting up a transport mechanism for a continuous media stream from the media server. The PoC client, or the user terminal in which the PoC client according to an embodiment resides, or a control unit or any other corresponding means in the user terminal, is configured to share a media stream from the media server by controlling the setting up of the transport mechanism for the media stream, as described in detail below, especially in connection with FIG. 5. A client may be shipped with the user terminal, or it may be a downloadable plug-in to the user terminal, or otherwise later added to the user terminal. In addition, a PoC client according to an embodiment may be implemented by modifying a PoC client in the user terminal to be a PoC client according to the embodiment. As regards the other user terminals B 1-1′ and C 1-1″, they may be similar to the user terminal A or they may be conventional user terminal supporting PoC. For the implementation of an embodiment it will suffice that one user terminal has a client capable of setting up the transport mechanism according to the embodiment, the receiving user terminals need not to have such a client.

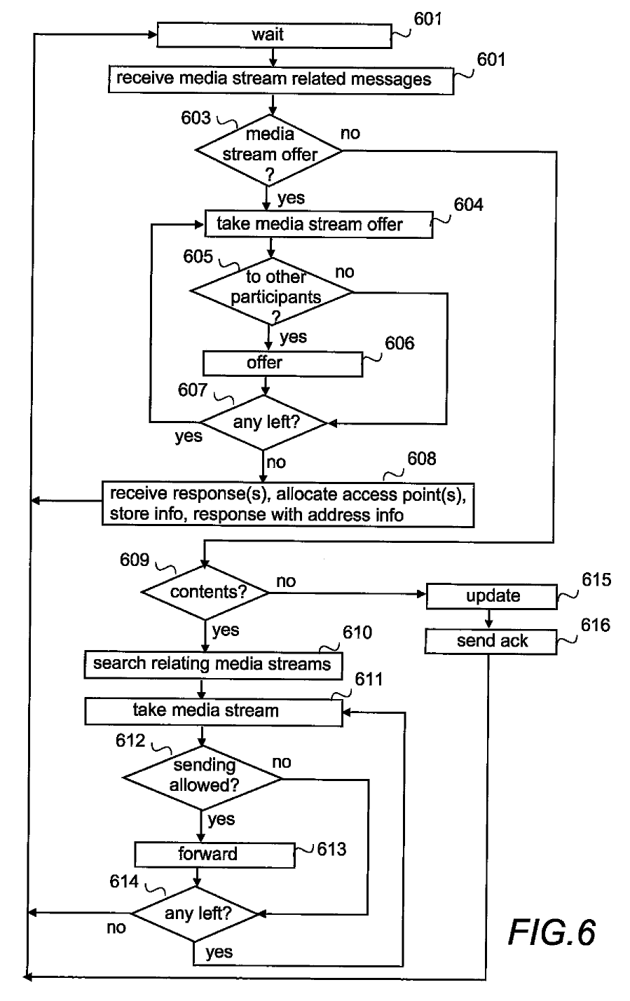

PoC AS 1-3, i.e. the PoC application server, provides the group communication and contents sharing, and is the signalling endpoint of the PoC service. In other words, PoC AS receives media from user terminals and sends it further to other user terminals. In addition, PoC AS 1-3 according to an embodiment is configured to contain a functionality to be described below, especially in connection with FIG. 6. Herein, the term “PoC AS” is used for referring to any communication server or a corresponding server system providing the user communications services, and abbreviation “PoC” for referring any application and service providing group communication.

In the example of FIG. 1, PoC AS 1-3 is a logical node including a conference server 1-31, a multimedia resource function processor MRFP 1-32 and a multimedia resource function controller MRFC 1-33, which are elements of a conferencing architecture. It is obvious to one skilled in the art that the logical node may be implemented so that one physical node, such as a server, may comprise all of these elements or only some of them. However, for the sake of clarity, the logical node is used in the following description.

The media server 1-4 is a server providing at least playback services for one or more media streams which may be combined into a multimedia presentation. (Typically, an audio stream and a video stream are different media streams.) In the example of FIG. 1, the media server is a logical node also containing contents 1-41 which may be shared. It is obvious to one skilled in the art that the contents may be physically obtainable from another network node and that different media streams within a presentation may originate from different media servers. However, for the sake of clarity, the logical node is used in the following description. The media server 1-4 may be external to the PoC, or it may be a PoC element containing the contents or otherwise providing the contents as obtainable to users, such as a PoC box for playing stored contents of a stored PoC conversation. The embodiment(s) may be implemented with media servers capable of sending a media stream to an address other than an address from which the media stream is controlled.

FIG. 2 illustrates signalling according to an embodiment. In the example it is assumed, for the sake of clarity, that a PoC session between user terminals A, B and C already exists. However, the signalling described below could be implemented also during a session establishment. Further assumptions are that the signalling illustrated in FIG. 2 utilizes SIP, the Real-time Transport Protocol (RTP) (RFC 1889) for transporting real-time data and providing QoS feedback, the Real-Time streaming protocol (RTSP) (RFC 2326) for setting up the media stream and for controlling the media stream, and the Session Description Protocol (SDP) (RFC 2327) for describing multimedia sessions. They all are protocols specified by IETF for building up a complete multimedia architecture, and more information on them can be found via the above-mentioned Internet page. However, as was stated above, the protocols used are irrelevant to the invention. Furthermore, it is assumed, for the sake of clarity, that the contents to be shared are available in a media server and that the user terminal A (or the user of the user terminal A) knows some details about the contents, such as the contents' address, i.e. an RTSP URL (uniform resource locator) identifying the resource, indicating how to locate it, the protocol used, and the coding.

FIG. 2 starts when the user of the user terminal A wishes to share the contents with users of the user terminals B and C. Therefore, the user terminal A starts media negotiations with the user terminals B and C, or more precisely the user terminal A starts the negotiations with PoC AS which then negotiates with the user terminals B and C, by using an SDP offer/answer mechanism. As a first step in the SDP offer/answer mechanism, the user terminal A sends an SDP offer in an INVITE request 2-1 to PoC AS. (Since in the example the session already exists, the request can be considered as a re-INVITE.) The request contains two media stream offers for the contents, m grouped together and having the same media type and the same coding, but one of the media stream offers indicating to PoC AS that this media stream is not to be offered to other participants, i.e. to the user terminals B and C. In other words, an end-point of said one of the media stream negotiation is PoC AS.

Because the other media stream is to be offered to other participants, PoC AS sends an SDP offer in INVITE requests 2-2 and 2-2′ to the user terminals B and C; the requests containing one media stream offer for the contents.

In the example, the user of the user terminal B accepts the offered media stream but the user of the user terminal C does not accept the offered media stream, i.e. does not wish to obtain the contents. Therefore, the user terminal B sends an SDP answer in 200 OK response 2-3 to PoC AS but the user terminal C does not accept the offered media stream and sends a response 2-4 to PoC AS. In this example, the response 2-4 is a 200 OK indicating in an SDP answer that the offered media is not accepted.

In the example, after receiving the responses/SDP answers, PoC AS sends an SDP answer in a 200 OK response 2-5 to the user terminal A. The SDP answer contains acceptances of both offered media streams with addresses. In other words, the response 2-5 contains an address for each media stream, at which PoC AS, or more precisely, MRFP, will receive the offered media stream. In addition, PoC AS will store or otherwise maintain media stream-related information indicating the accepted media streams and their details.

The user terminal A initializes contents transport from the media server by sending an RTSP DESCRIBE in message 2-6 to the media server, said message identifying the contents and asking for a description of the contents. The media server sends a 200 OK response 2-7 including an SDP description with details relating to a media stream for the contents, such as the coding. This transport initialization may be performed during the above-illustrated signalling, or before it (in order to find out the details of the contents, for example).

After receiving the response 2-5, the user terminal A knows an address in PoC AS whereto the contents is to be delivered in order for the contents to be shared, and it starts (provided that transport initialization has been performed) setting up a transport mechanism for the continuous media stream intended to deliver the contents by sending an RTSP SETUP in message 2-8 to the media server; the RTSP SETUP presenting the address in PoC AS as a destination address whereto the media stream is to be sent. The media server sends a 200 OK response 2-9 including, among other things, an address in the media server at which it receives instructions relating to the media stream.

Now the user terminal A knows the address wherefrom the contents are delivered and other actual media details and sends another INVITE request 2-10 to PoC AS, said other INVITE request including an updating SDP offer with proper details about the media stream between the media server and PoC AS. The request 2-10 contains the two media stream offers for the contents in request 2-1 with updated media details, one of the updated detail being the address in the media server, as a source address for the media stream.

In response to receiving the request 2-10, PoC AS updates the media stream-related information to be in accordance with the information in the request 2-10. If a media detail in the media stream offer that was offered to the other participants has been updated, i.e. is not the same as in request 2-1, PoC AS will update the media stream information to the user terminal B. However, in the example of FIG. 2, no updating is necessary. After updating the media stream-related information, PoC AS sends an SDP answer in a 200 OK response 2-11 to the user terminal A.

As a result, a transport mechanism for the contents is set up between the servers so that the media stream will pass from the media server to PoC AS but the control of the media stream is with the user terminal A. As can be seen from the above, PoC AS does not know that the media stream is received from the media server, and the media server does not know that the media stream is sent to PoC AS.

When the transport mechanism has been set up, the user of the user terminal A wishes to share the contents and sends an RTSP PLAY in message 2-12 to the media server. In response to the RTSP PLAY, the media server responds with an RTSP 200 OK response 2-13 and sends the contents in an RTP stream 2-14 to PoC AS. When receiving the RTP stream 2-14 PoC AS notices that media streams grouped together and having the same media type and coding exist as the received RTP stream, said media streams allowing PoC AS to send media streams. Therefore, PoC AS relays the contents in RTP streams 2-14 to the user terminals A and B, i.e. to participants that accepted the contents offer, and to the participant from whom the contents offer originated. They receive the contents approximately at the same time.

For example, if the contents consists of video, the user of the user terminal A can start, hold/resume, forward, rewind etc. the contents and tear down the media stream between PoC AS and the media server. This enables, if voice has been negotiated to bee included the PoC session, the users of the user terminal A and B to discuss the contents, for example.

The above-described embodiment may also be implemented when a floor control is used for media streams. In such a case, the user terminal A performs the floor control request and release, and PoC AS that grants the floor, is prepared to receive media streams from any source controlled by the user terminal A.

As can be seen from the above, an advantage of the illustrated embodiment is that the group server and the media server need not support the same negotiation protocol since the user terminal negotiates with each server using the negotiation protocol the server supports. However, the servers may support the same protocol(s).

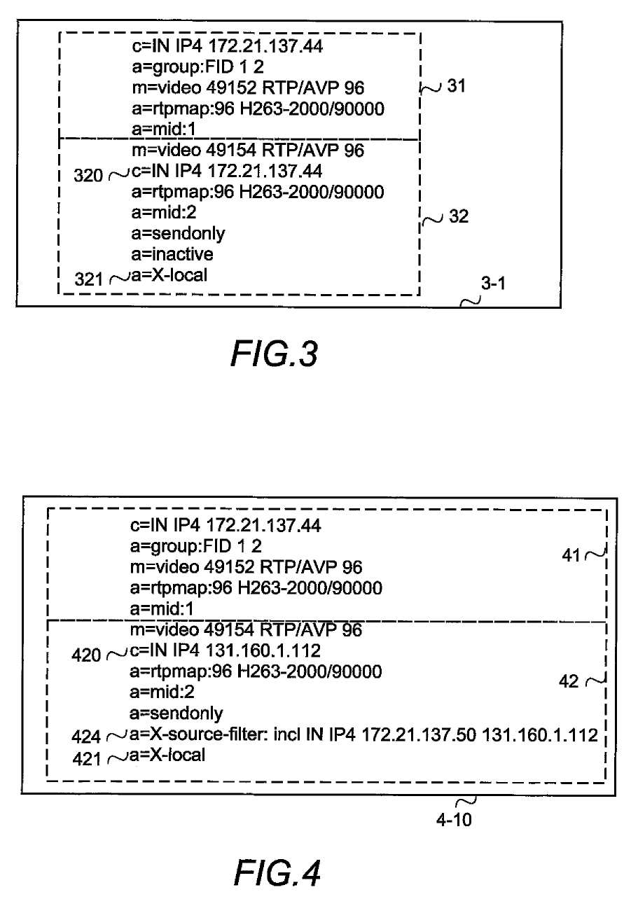

FIGS. 3 and 4 disclose SDP descriptions according to an embodiment, which are used in messages between a PoC client and PoC AS when the transport mechanism for the contents is negotiated. The messages may be any suitable signaling messages but, for the sake of clarity, they are herein illustrated as a simplified SDP description not containing, for the sake of clarity, all possible headers and parameters. FIG. 3 discloses a message 3-1 including a first offer, i.e. it is an example of the request 2-1 in FIG. 2, and FIG. 4 relates to updating the first offer, i.e. a message 4-10 in FIG. 4 is an example of the request 2-10 in FIG. 2. In the illustrated example, the contents consist of video.

The message 3-1 in FIG. 3 comprises two stream offers 31 and 32 for the video. The message may also contain other stream offers. The stream offer 31 indicates that it is to be offered to other participants in the session in question and that it can be used for sending and receiving. The stream offer 32 has a new attribute 321 “a=X-local” which indicates that the stream offer is not to be offered to the other participants. The stream offer 32 is a send only stream offer, and therefore PoC AS only receives video from the address given by a second connection attribute 320 but sends no contents to the address. Since the user terminal A does not yet know the proper address of the contents, the message 3-1 indicates that the video stream originates from the user terminal A, i.e. the value of the attribute 320 is the address of the user terminal A. In addition, in the example the stream offer 32 is inactive since the details are not yet fixed. As can be seen, both media streams are for video, are grouped together and have the same coding.

A message 4-10 in FIG. 4 comprises two stream offers 41 and 42 for the video. The message may also contain other stream offers. In this example, the stream offer 41 is identical to the stream offer 31 in FIG. 3 but the stream offer 42 does not have the same contents as the stream offer 32. In the stream offer 42, a second connection attribute 420 defines the address wherefrom the video is received to be an address in the media server, i.e. the address of the user terminal A is updated to the proper address. In addition, it has an attribute 424 defining a source filter which indicates wherefrom the proper stream comes to ensure that a hacker cannot use the media stream for faked contents. Instead of the attribute 424 illustrated in FIG. 4, some other attribute for the same purpose may be defined and used, or no attribute 424 is used. The stream offer 42 preferably contains the new attribute “a=X-local” (attribute 421). Since the stream details are now known, this stream is no longer indicated as inactive.

FIG. 5 is a flow chart illustrating functionality of a user terminal according to an embodiment when a user of the user terminal wishes to share contents in a media server with other participants in a group communication provided by a communication server. Therefore, the user terminal requests, in step 501, from a communication server at least a first and a second media stream for the contents, the first requested media stream allowing forwarding the media stream request to other group members, the second requested media stream disallowing the forwarding. The request preferably contains the same value(s) of one or more associating attributes, such as a flow identifier, with which the streams are bound to each other. In other words, the user terminal is configured to request delivery of contents with two or more media streams, and indicating in the request that information on at least one of the requested media streams is not to be forwarded to the other participants, whereas information on at least one of the requested media streams is to be forwarded to the other participants. An indication may be an explicit or an implicit indication. For example, no indication may indicate that a media stream is to be forwarded to other participants.

In the example illustrated in FIG. 5, a user terminal receives, in step 502, from a communication server an acceptance of requested first and second media streams, said acceptance preferably containing for each media stream an address whereto the media stream can be delivered and/or wherefrom the media stream is received. The user terminal takes, in step 503, from the acceptance the address whereto the second media stream can be delivered to be a target address for the media stream, and requests, in step 504, the media server to deliver the contents to the target address. In other words, the user terminal requests a media server to deliver the contents to the communication server by using the target address as if the communication server were the user terminal.

In the example illustrated in FIG. 5, the user terminal receives, in step 505, from the media server an acceptance for the delivery request, said acceptance containing an address wherefrom the contents are to be delivered. The user terminal takes, in step 506, this address to be a source address for the media stream, and redirects, in step 507, the other end of the second media stream from the user terminal to the media server, more precisely to the source address, as if the media server were the user terminal. Because of the source and target addresses, the actual media stream is between the media server and the communication server, although they are not aware of it.

After that the user, and the user terminal controls (step 508) the media stream between the media server and the communication server although the contents delivery is (will be) from the media server to the communication server.

As can be seen from the above, according to an embodiment, tasks of a user terminal are to control setting up a transport mechanism for contents between a media server and a communication server by obtaining required media details from the servers and delivering required media details to the servers, to control to whom the contents are to be offered by the communication server and to control the delivery of the contents between the media server and the communication server. The required media details include address information in the servers.

FIG. 6 is a flow chart illustrating functionality of a communication server according to an embodiment. In FIG. 6, it is assumed for the sake of clarity, that the communication server receives both instructions (signaling) and actual contents in messages. In addition, FIG. 6 only illustrates functionality relating to messages that relate to media streams, and it is assumed that no updates to a media stream/media streams are sent in the same message as offers to a new media stream/media streams.

The communication server waits (step 601) until it receives, in step 602, a media stream-related message. If the message contains one or more media stream offers (step 603), the communication server takes, in step 604, a media stream offer, and checks, in step 605, whether or not the media stream offer is to be offered to other participants in the group communication in question. If yes, the communication server offers, i.e. sends, in step 606, the media stream offers to the other participants, waits for their responses, receives the responses and stores, or otherwise maintains, media stream-related information, such as whether or not the offered media stream was accepted and value(s) of one or more associating attributes of the stream, discussed above in connection with FIG. 5. Then (or meanwhile) the communication server checks whether or not all media stream offers are processed (step 607). If no, the communication server takes another media stream offer to be processed. In other words, it returns to step 604.

If the media stream offer is not intended to other participants (step 605), the communication server proceeds directly to step 607 to check whether or not all media stream offers have been processed.

After all media stream offers have been processed (step 607) and responses received, the communication server allocates, in step 608, preferably for each media stream, a port or corresponding access point and sends, in step 608, a response to the participant from whom the message containing the media stream offers was received. The response contains address information to the communication server, said address information indicating the addresses of the access points or ports to be used with media streams. Next, the communication server returns to step 601 to wait for another message.

If the message contains contents (step 609), i.e. is the actual media stream, the communication server searches, in step 610, for other relating media streams. The other relating media streams are found on the basis of the value(s) of the one or more associating attributes. In the illustrated example it is assumed, for the sake of clarity, that at least one media stream is found. Then the communication server takes, in step 611, a media stream that was found, and checks, in step 612, whether or not the media stream allows sending from the contents server to the other end of the media stream, and if sending is allowed, forwards, in step 613, the contents to the other end. Then (or meanwhile) the communication server checks whether or not all media streams have been processed (step 614). If no, the communication server takes another media stream to be processed. In other words, it returns to step 611.

If the media stream does not allow sending (step 612), the communication server proceeds directly to step 614 to check whether or not all media streams have been processed.

After all relating media streams have been processed (step 614), the communication server returns to step 601 to wait for another message.

If the message contains no offer (step 603), nor contents (step 609), it contains an update of at least one media stream, and the communication server performs, in step 615, the updating, and sends, in step 616, a message acknowledging the received message. Then the communication server returns to step 601 to wait for another message.

In another embodiment, the communication server is further configured to transcode contents received from a media server to a media type supported by user terminals, if transcoding is necessary.

As can be seen from the above, no need exists to arrange the communication server to control the media stream originating from the media server; it can be handled as if it were received from a user terminal.

The steps, points and signaling messages shown in FIGS. 2, 3, 4, and 6 are in no absolute chronological order, and some of the steps/points may be performed simultaneously or in an order different from the given one. Other functions can also be executed between the steps/points or within the steps/points. For example, the user terminal may first send contents and after that update the media stream so that further contents are sent from the media server. In addition, a contents source may be changed (updated) several times. Some of the steps/points or part of the steps/points can also be omitted. The signaling messages are only exemplary and may even comprise several separate messages for transmitting the same information. In addition, the messages may also contain other information. The messages and steps/points can also be freely combined or divided into several parts. For example, the media stream offers 31 and 32 in FIG. 3 may be sent in separate messages. Furthermore, the names, types and/or contentss of the messages may differ from the above-mentioned ones, as well as the protocols used.

Although in the above embodiments the media stream “not to be offered” is indicated, it is obvious to one skilled in the art how to implement embodiments in which the media stream “to be offered to other participants” is indicated instead, and a media stream without such an indication is interpreted as not to be offered to other participants.

Although in the above embodiments it is assuming that the contents are shared in one-to-many communication, it is obvious to one skilled in the art that the communication may as well be one-to-one communication.

Apparatuses, such as the user terminal, communication server or corresponding server component and/or other corresponding device implementing the functionality of a corresponding apparatus described with an embodiment comprises not only prior art means but also means for sharing information in the manner described above. More precisely, they comprise means for implementing functionality of a corresponding apparatus described with an embodiment and they may comprise separate means for each separate function, or means may be configured to perform two or more functions. Although in the above each apparatus has been depicted as one entity, different modules and memory may be implemented in one or more physical or logical entities. Present apparatuses comprise processors and memory that can be utilized in the functions according to an embodiment. For example, the PoC client 1-11, the media client 1-12, the conference server 1-31, the MRFP 1-32, and/or the MRFC 1-22 may be a software application, or a module, or a unit configured as arithmetic operation, or as a program (including an added or updated software routine), executed by an operation processor. Programs, also called program products, including software routines, applets and macros, can be stored in any apparatus-readable data storage medium and they include program instructions to perform particular tasks. All modifications and configurations required for implementing functionality of an embodiment may be performed as routines, which may be implemented as added or updated software routines, application specific integrated circuits (ASIC) and/or programmable circuits. Further, software routines may be downloaded into an apparatus. The apparatus, such as a server, or a corresponding server component, or a user terminal may be configured as a computer or a microprocessor, such as single-chip computer element, including at least a memory for providing storage area used for arithmetic operation and an operation processor for executing the arithmetic operation. An example of the operation processor includes a central processing unit. The memory may be removable memory detachably connected to the apparatus.

It will be obvious to a person skilled in the art that as technology advances, the inventive concept can be implemented in various ways. The invention and its embodiments are not limited to the examples described above but may vary within the scope of the claims.

1. A method comprising:
setting up, by an apparatus, at least a first and a second media stream for a contents stored in a media server, said first media stream being between the apparatus and a communication server, and said second media stream being between the communication server and the media server to be used for delivering
the contents in the second media stream from the media server to the communication server; and
controlling the second media stream by the apparatus.

2. A method as claimed in claim 1, wherein the setting up comprises at least the following:
requesting, by the apparatus, from the communication server at least the first and the second media stream;
receiving in the apparatus an acceptance of the first and second media streams from the communication server, said acceptance containing a first address for the media stream in the communication server;
requesting, by the apparatus, the media server to deliver the contents to the communication server by using the first address as a target address in the request;
receiving in the apparatus a response from the media server, said response containing a second address for the media stream in the media server; and
updating the source address of the second media stream to be the second address.

3. A method as claimed in claim 1, further comprising:
using a session description protocol offer answer mechanism between the apparatus and the communication server;
using a real-time streaming protocol between the apparatus and the media server; and
using a real-time transport protocol when delivering the contents.

4. An apparatus comprising a processor configured to
set up a transport mechanism between a communication server providing group communication and a media server for contents in the media server; and
control delivery of the contents between the media server and the communication server.

5. An apparatus comprising a control unit configured to set up a transport mechanism between a communication server providing group communication and a media server for contents in the media server; and to control delivery of the contents between the media server and the communication server.

6. An apparatus as claimed in claim 5, wherein the control unit is further configured, during the setting up, to obtain a target address from the communication server and a source address from the media server, and to send the target address to the media server and the source address to the communication server.

7. An apparatus as claimed in claim 5, wherein the control unit is further configured, during the setting up, to request from the communication server at least a first and a second media stream; to receive an acceptance of the first and second media streams from the communication server, said acceptance containing a first address in the communication server; to request the media server to deliver contents to the communication server by using the first address as a target address in the request; to receive a response from the media server, said response containing a second address in the media server; and to update the source address of the second media stream to be the second address.

8. An apparatus as claimed in claim 5, wherein the control unit is a processor connected to a receiver and a transmitter of the apparatus.

9. An apparatus as claimed in claim 5, wherein the control unit is implemented as containing:
setting up means for setting up a transport mechanism between the media server and the communication server for contents in the media server; and
means for controlling the delivery of the contents between the media server and the communication server.

10. An apparatus as claimed in claim 9, wherein the control unit further contains:
means for obtaining a target address from the communication server and a source address from the media server, the means for obtaining being responsive to the setting up means to perform the obtaining during the setting up, and
means for sending the target address to the media server and the source address to the communication server.

11. An apparatus as claimed in claim 9, wherein the control unit further contains:
means for requesting from the communication server at least a first and a second media stream, the means for requesting being responsive to the setting up means to perform the obtaining during the setting up,
means for receiving an acceptance of the first and second media streams from the communication server, said acceptance containing a first address in the communication server;
means for requesting the media server to deliver contents to the communication server by using the first address as a target address in the request;
means for receiving a response from the media server, said response containing a second address in the media server; and
means for updating the source address of the second media stream to be the second address.

12. An apparatus as claimed in claim 4, further configured to use during the setting up a first protocol with the communication server and a second protocol with the media server.

13. An apparatus as claimed in claim 14, wherein the processor is configured to implement means for recognizing and accepting a media stream offer which is not to be forwarded to group members.

14. An apparatus comprising an application server component configured to provide a group communication service and a processor configured to recognize and accept a media stream offer which is not to be forwarded to group members.

15-17. (canceled)

18. A computer-readable medium comprising program instructions, wherein execution of said program instructions causes an apparatus, configured to communicate with a media server containing contents and a communication server providing contents sharing in a group communication, to set up a transport mechanism between the media server and the communication server for the contents and to control delivery of the contents between the media server and the communication server.

19. A computer readable medium as claimed in claim 18, wherein execution of said program instructions causes the apparatus further to request from the communication server at least the first and the second media stream; to receive an acceptance of the first and second media streams from the communication server, said acceptance containing a first address for the media stream in the communication server; to request the media server to deliver the contents to the communication server by using the first address as a target address in the request; to receive a response from the media server, said response containing a second address for the media stream in the media server; and to update the source address of the second media stream to be the second address.

20. A method as claimed in claim 1, further comprising:
requesting establishment of a further media stream from the communication server to another apparatus; and
sharing the content using the first and the further media stream.

21. An apparatus as claimed in claim 5, further being configured to use during the setting up a first protocol with the communication server and a second protocol with the media server.

22. An apparatus as claimed in claim 4, wherein the apparatus is a user terminal.

23. An apparatus as claimed in claim 5, wherein the apparatus is a user terminal.

24. An apparatus as claimed in claim 13, wherein the apparatus is a communication server.

25. An apparatus as claimed in claim 14, wherein the apparatus is a communication server.

26. An apparatus configured to obtain contents to be delivered in a media stream, to receive instructions controlling the media stream from an address of an apparatus, and to deliver the contents in the media stream to an address other than the address from which the media stream is controlled.

27. An apparatus as claimed in claim 26, wherein the apparatus is a media server.
